(19) United States
(12) Patent Application Publication
(10) Pub. No.: US 2006/0237871 A1
(43) Pub. Date: Oct. 26, 2006

(54) Insert molding device and insert molding method

(75) Inventor: Yasunori Uchida, Nishikasugai-gun (JP)

Correspondence Address: POSZ LAW GROUP, PLC, 12040 SOUTH LAKES DRIVE, SUITE 101, RESTON, VA, 20191, US

(73) Assignee: Toyoda Gosei Co., Ltd., Aichi-Ken (JP)

(21) Appl. No.: 11/405,415

(22) Filed: Apr. 18, 2006

(30) Foreign Application Priority Data
Apr. 26, 2005 (JP) 2005-128419

(51) Int. Cl. B29C 45/14

(52) U.S. Cl. 264/275; 425/116

(57) ABSTRACT

To provide an insert molding device for producing, by insert molding, a molded product which includes an insert member and a long resin member formed on at least one of front and back faces of the insert member, whereby deformation of the insert member is restrained, and an insert molding method. The insert molding device is provided with a film gate, and a gate end part of the film gate which is a communication port with a cavity is open to a front forming surface.

### BACKGROUND OF THE INVENTION

1. Field of the Invention

The present invention relates to a mold for producing, by insert molding, a molded product which includes an insert member and a resin member, and a method of molding the same.

2. Related Art

As a method of producing a molded product which includes an insert member and a long resin member formed on at least one of front and back faces of the insert member, a dipping method has been known. The dipping method includes steps of dipping the insert member in a liquid tank containing molten resin material, then, withdrawing the insert member from the liquid tank, and setting the molten resin material thereby to cover the insert member with the resin member. By employing the dipping method, it is possible to form the resin member without deforming the insert member, but on the other hand, there has been such a problem that production cost will be increased due to long molding cycle.

As the molding method having a short molding cycle and low production cost, an insert molding method has been known. The insert molding method, which is a kind of injection molding methods, is a method of molding a resin member by injecting molten resin material into a cavity of a mold in which an insert member is contained.

In this case, in order to form a long resin member, the molten resin material must be injected into the cavity of the mold at high pressure. However, there has been a problem that the insert member may be deformed with fluid pressure of the molten resin material, because the fluid pressure of the molten resin material inside the cavity is varied depending on sections. Particularly, in case where a plurality of strip bodies which are arranged along a longitudinal direction in parallel with and separated from each other are employed as the insert member, the insert member is liable to be deformed with the fluid pressure of the molten resin material. Specifically, in case where the insert member includes a plurality of the strip bodies, the molten resin material flows also into gaps (hereinafter referred to as “intermediate cavities”) between the respective strip members. Since the insert member includes a plurality of the strip bodies, the intermediate cavities are formed at a plurality of positions. The molten resin material flows, by preference, into the intermediate cavity into which the molten resin material has entered with high fluid pressure, among a plurality of the intermediate cavities, and this intermediate cavity will be enlarged. On the other hand, the intermediate cavity adjacent to this enlarged intermediate cavity will be contracted. Accordingly, the insert member will be deformed with the fluid pressure. Particularly, in case where the strip bodies each having a length/thickness ratio of 10 or more are employed as the insert member, the insert member will be remarkably deformed, because the strip bodies have thin walls and long lengths.

There has been another insert molding method in which the molten resin material is injected, while the insert member is secured in the mold with a pin, thereby to prevent deformation of the insert member. It is considered that by employing this method, deformation of the insert member including a plurality of strip bodies having the length/thickness ratio of 10 or more and arranged along the longitudinal direction, in parallel with and separated from each other (hereinafter referred to as “the insert member”) can be restrained. In this case, it is said that by withdrawing the pin in a state where the molten resin material has not yet been completely set, a pin hole will be closed by internal pressure of the molten resin material. However, it is extremely difficult to detect whether the pin hole has been completely closed or not. Therefore, in case where the molded product having no pin hole is requested, for example, in case where an insulating layer is formed of the resin member, this method has been inappropriate.

Japanese Patent Publication No. JP-A-5-228967 discloses an injection molding method in which a wide and thin-walled film gate is employed as a gate communicated with a cavity of a mold. In the injection molding method disclosed in JP-A-5-228967, a gate end part of the film gate which is a communicating port with the cavity is so provided as to extend in a direction parallel to the direction in which molten resin material is to be flowed. Specifically, the gate end part is provided on a mold face in the cavity for forming a side face of a resin member (hereinafter called as “a side forming surface”), and the molten resin material is injected along a longitudinal direction of the resin member. As the results, fluid pressure of the molten resin material in the cavity will be made uniform.

It is considered that deformation of the insert member can be restrained, by applying the injection molding method disclosed in JP-A-5-228967 to the insert molding method. However, there is such a problem that in the mold for molding a thin-walled resin member, the side forming surface has a very small area, and it is impossible to form the gate end part of the film gate on the side forming surface.

### SUMMARY OF THE INVENTION

The invention has been made in view of the above described circumstances, and an object of the invention is to provide an insert molding device for producing, by insert molding, a molded product which includes an insert member and a long resin member formed on at least one of front and back faces of the insert member, whereby deformation of the insert member is restrained, and an insert molding method employing the mold.

In order to solve the above described problem, there is provided, according to the invention, an insert molding device for forming a molded product by insert molding which includes an insert member provided with a plurality of long strip bodies which are extended in a longitudinal direction so as to be in parallel with and separated from each other and each of which has a length/thickness ratio of 10 or more, and a long resin member formed on at least one of front and back faces of the insert member, the insert molding device comprising:

a cavity for receiving the insert member and for molding the resin member; and

a film gate communicated with the cavity;

wherein a gate end part of the film gate is open to a front forming surface on the cavity to form a front face of the resin member, so that the gate end part extends in a direction intersecting the longitudinal direction of the insert member.

Preferably, the insert molding device according to the invention may have either of the following structures (1) to (3).

(1) A buffer part in a concave shape is formed on the front forming surface in an area including the gate end part.

(2) The insert molding device has a back forming surface to form a back face of the resin member at a position opposed to the front forming surface, and the back forming surface is provided with a back buffer part in a concave shape which is communicated with the buffer part at a position opposed to the buffer part.

(3) The gate end part extends in a direction perpendicular to the longitudinal direction of the insert member.

In order to solve the above described problem, there is provided, according to an other aspect of the invention, a molding method for molding a molded product by insert molding which includes an insert member provided with a plurality of long strip bodies which are extended in a longitudinal direction so as to be in parallel with and separated from each other and each of which has a length/thickness ratio of 10 or more, and a long resin member formed on at least one of front and back faces of the insert member, the molding method comprising the steps of:

employing an insert molding device which a cavity for receiving the insert member and for molding the resin member; and a film gate communicated with the cavity, wherein a gate end part of the film gate is open to a front forming surface on the cavity to form a front face of the resin member, so that the gate end part extends in a direction intersecting the longitudinal direction of the insert member,

mounting the insert member in the cavity,

injecting molten resin material to the cavity through the film gate from a direction intersecting a front face of the insert member.

Preferably, the molding method according to the invention may have either of the following structures (4) to (6).

(4) A buffer part in a concave shape is formed on the front forming surface in an area including the gate end part, whereby, in the injecting step, the molten resin material flows first into the buffer part in the cavity.

(5) The insert molding device has a back forming surface which defines a part of the cavity to form a back face of the resin member, at a position opposed to the front forming surface, and the back forming surface is provided with a back buffer part in a concave shape which is communicated with the buffer part, at a position opposed to the buffer part, whereby, in the injecting step, the molten resin material flows first into the buffer part, and subsequently into the back buffer part.

(6) The gate end part of the insert molding device extends in a direction perpendicular to the longitudinal direction of the insert member, whereby, in the injecting step, the molten resin material flows into respective gaps between a plurality of the strip bodies substantially at the same time, and flows into the respective gaps between a plurality of the strip bodies substantially by the same position in the longitudinal direction.

According to the insert molding device of the invention, the gate end part is open to the front forming surface. In the cavity for forming the resin member, the front forming surface for forming the front face of the resin member has a very large area as compared with a side forming surface for forming a side face of the resin member. Accordingly, the gate end part of the film gate can be easily formed. In this manner, by employing the insert molding device according to the invention, it is possible to inject the molten resin material into the cavity through the film gate. As the results, the fluid pressure of the molten resin material inside the cavity will be made uniform.

In case where the molten resin material is injected into the intermediate cavities, that is, the gaps between the strip bodies, the strip bodies will be deformed if the fluid pressure of the molten resin material is high. Thus, the molded product having the intermediate cavities which are not uniformly filled with the resin material will be obtained. Because the insert molding device according to the invention has the film gate, the fluid pressure of the molten resin material flowing along the front and back faces of the insert member in the cavity will be made uniform. Moreover, the gate end part has a shape of extending in the direction intersecting the longitudinal direction of the insert member, whereby the molten resin material flows into the intermediate cavities simultaneously (or substantially at the same time), and the fluid pressure of the molten resin material flowing in the intermediate cavities will be made uniform. As the results, it is possible to produce, by insert molding, the molded product in which the intermediate cavities are uniformly filled with the resin material, and deformation of the insert member is restrained. In the insert molding device according to the invention, each of the strip bodies constituting the insert member has a length/thickness ratio of 10 or more. The length of the strip body means a length of the strip body in the longitudinal direction of the long resin member. The thickness of the strip body means a wall thickness of the strip body or a width of the strip body. The strip body having the length/thickness ratio of 10 or more has a thin wall thickness and a long length, and is liable to be deformed when the conventional insert molding device is employed for insert molding. By employing the insert molding device according to the invention, deformation of the strip body can be effectively prevented for the above described reason. The insert molding device according to the invention is particularly advantageous, in case where the wall thickness of the resin member is 2 mm or less, or a holding pin cannot be provided in the mold for insert molding.

In case where the insert molding device according to the invention has the above described structure (1), the molten resin material injected into the cavity through the gate end part will flow first into the buffer part in the cavity. Therefore, the fluid pressure of the molten resin material will be lowered and made uniform in the buffer part, and the molten resin material will flow to a common part of the cavity. For this reason, the deformation of the insert member will be further restrained.

In case where the insert molding device according to the invention has the above described structure (2), it is possible to produce, by insert molding, the molded product in which the long resin member is formed on at least one of the front and back faces of the insert member, and the deformation of the insert member is restrained.

Specifically, the molten resin material injected into the cavity through the gate end part will flow first into the buffer part, and subsequently into the back buffer part. Thereafter, the molten resin material will flow into the common part of the cavity from the buffer part and the back buffer part. The molten resin material flowing from the buffer part whose fluid pressure has been lowered and made uniform in the buffer part will flows along the front forming surface of the common part. The molten resin material flowing from the back buffer part whose fluid pressure has been lowered and made uniform in the buffer part and back buffer part will flow along the back forming surface of the common part. In this manner, the resin member can be formed on the front face and the back face of the insert member, while the deformation of the insert member is restrained.

In case where the insert molding device according to the invention has the above described structure (3), the molten resin material will flow into the intermediate cavities simultaneously (or substantially at the same time), and, at the same time, will be injected to the intermediate cavities at the same position in the longitudinal position. As the results, the molten resin material flowing inside the intermediate cavities will be further made uniform.

The molding method according to the invention is a molding method in which the insert molding device according to the invention is employed. Therefore, it is possible to produce, by insert molding, the molded product in which the long resin member is formed on at least one of the front and back faces of the insert member, and the deformation of the insert member is restrained, according to the advantage derived from the above described insert molding device.

### BRIEF DESCRIPTION OF THE DRAWINGS

FIG. 1 is a sectional view schematically showing an insert molding device in an embodiment according to the invention cut in a longitudinal direction.

FIG. 2 is an explanatory perspective view schematically showing a cavity of the insert molding device in the embodiment.

FIG. 3 is a plan view schematically showing the cavity of the insert molding device in the embodiment.

### DETAILED DESCRIPTION OF THE PREFERRED EMBODIMENTS

Now, the insert molding device and the insert molding method according to the invention will be described referring to the drawings.

### EMBODIMENT

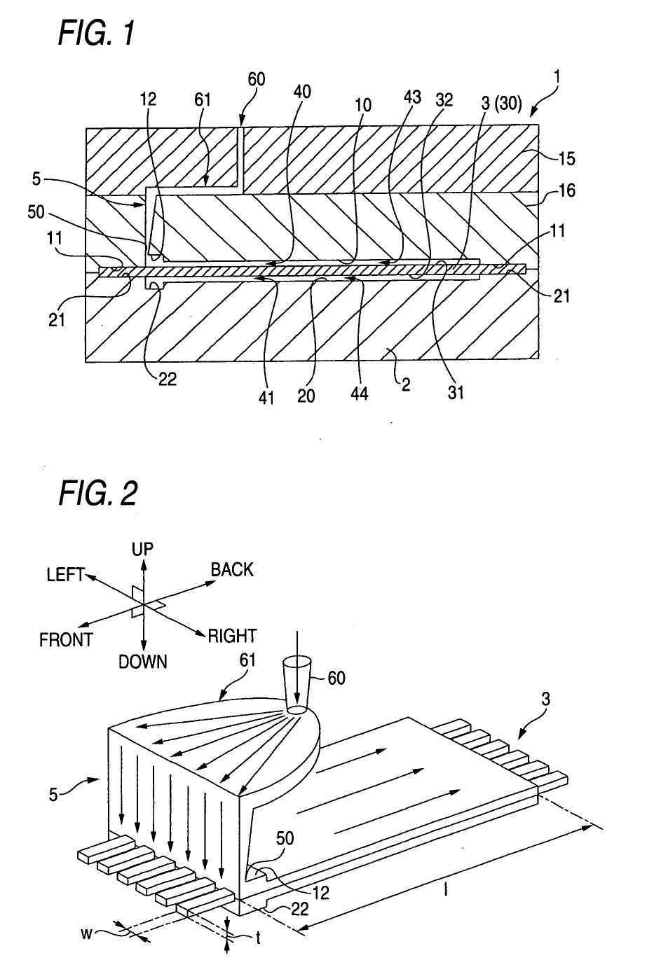

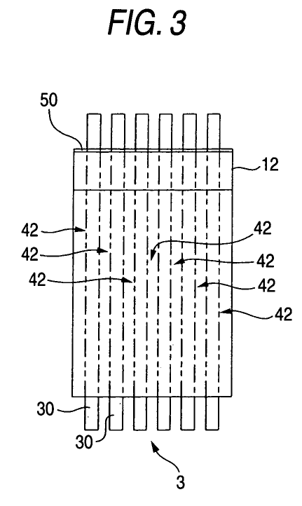

The insert molding device in the embodiment has the above described structures (1), (2) and (3). The insert molding method in the embodiment has the above described structures (4), (5) and (6). FIG. 1 is a sectional view schematically showing the insert molding device in the embodiment cut in a longitudinal direction, FIG. 2 is an explanatory perspective view schematically showing a cavity and a film gate of the insert molding device in the embodiment, and FIG. 3 is a plan view schematically showing the cavity of the insert molding device in the embodiment. Designated by up, down, left, right, front and back in the following description are up, down, left, right, front and back in FIG. 2.

The insert molding device in the embodiment is formed by assembling two divided molds, namely, an upper mold 1 and a lower mold 2. The upper mold 1 and the lower mold 2 have inner spaces respectively, and a cavity is formed by assembling the inner space of the upper mold 1 and the inner space of the lower mold 2. A front forming surface 10 is formed in the upper mold 1, and a back forming surface 20 is formed in the lower mold 2. The front forming surface 10 and the back forming surface 20 are vertically symmetrically formed. Upper mounting faces 11 for mounting an insert member 3, which will be described below, are formed in front and back of the front forming surface 10 of the upper mold 1. The upper mounting faces 11 have a shape corresponding to an outer shape of the insert member 3. The upper mounting faces 11 are formed at a lower level than the front forming surface 10. The lower mold 2 is provided with the lower mounting faces 21 having a vertically symmetrical shape to the upper mounting faces 11.

The upper mold 1 is provided with a film gate 5. The film gate 5 is in a form of wedge in a sectional view, and extended in a lateral direction of the upper mold 1. An upper end of the film gate 5 has a larger width in the longitudinal direction, and a lower end of the film gate 5 has a smaller width in the longitudinal direction. The lower end of the film gate 5 is open to the front forming surface 10, and forms a gate end part 50. The gate end part 50 is formed at a forward end of the front forming surface 10. The upper end of the film gate 5 is communicated with a runner 61 which is continued to an injection port 60 of an injecting machine (not shown). Moreover, the gate end part 50 is so provided as to stride over all strip bodies 30, which will be described below. The upper mold 1 is divided in two, by the runner 60 as a boundary, into a first upper mold 15 and a second upper mold 16. The first upper mold 15 and the second upper mold 16 are integrated into the upper mold 1.

The front forming surface 10 has a buffer part 12 in a concave shape which is formed in an area including the gate end part 50. The buffer part 12 is extended in the longitudinal direction (direction to the front and to the back, in FIG. 2) and in the lateral direction (direction to the right and to the left, in FIG. 2). A length of the buffer part 12 in the longitudinal direction is uniform in the lateral direction.

The back forming surface 20 has a back buffer part 22 at a position opposed to the buffer part 12. The back buffer part 22 has a concave shape which is the same as the buffer part 12. The buffer part 12 and the back buffer part 22 are communicated with each other at their both ends in the lateral direction.

The insert molding method in the embodiment will be described below.

(Mounting Process)

As a first step, the insert member 3 was mounted in the cavity. In the insert molding method in this embodiment, the insert member 3 includes six strip bodies 30 each having a long length. The strip bodies 30 are arranged along the longitudinal direction, in parallel with each other at equal intervals. Each of the strip bodies 30 is formed of copper, having a wall thickness of 3 mm, a width of 2.5 mm, and a total length of 150 mm. In this embodiment, the length (designated by l, in FIG. 2) of the strip body 30 was 51 mm. Provided that the thickness (thickness t) of the strip body 30 is 3 mm, a length/thickness ratio of the strip body 30 was 17. Provided that the width (width w) of the strip body 30 is 2.5 mm, a length/width ratio of the strip body 30 was 20.4.

Opening the upper mold 1 and the lower mold 2, the insert member 3 was mounted on the lower mounting faces 21 in such a manner that a longitudinal direction of the insert member 3 may coincide with a longitudinal direction of the cavity. A face of the insert member 3 opposed to the upper mold 1 is a front face 31, whereas a face of the insert member 3 opposed to the lower mold 2 is a back face 32. After the insert member 3 had been mounted on the lower mounting faces 21, the upper mold 1 and the lower mold 2 were closed thereby to secure the insert member 3 between the lower mounting faces 21 and the upper mounting faces 11. Thus, the cavity was formed between the upper mold 1 and the lower mold 2. In the insert molding method in this embodiment, the cavity was divided into an upper section (an upper cavity 40) above the insert member 3 as a boundary, a lower section (a lower cavity 41) below the insert member 3, and gap sections (intermediate cavities 42) including gaps between the respective strip bodies 30 and gaps between side faces of the strip bodies 30 and mold faces of the mold. The upper cavity 40 and the lower cavity 41 have a height of 0.3 mm. Each of the intermediate cavities 42 has a height of 3.6 mm and a width of 0.5 mm.

(Injecting Process)

Molten resin material was injected through the film gate 5 into the cavity in which the insert member 3 had been mounted. Specifically, low viscosity resin material such as PPS, LCP which had been heated and melted was injected from an injecting machine, at a resin temperature of 270 to 280° C., and at an injection speed of 15 mm/s. The film gate 5 is provided with an opening valve which is not shown. The opening valve is adapted to open the film gate 5, when the molten resin material has been injected, and adapted to close the film gate 5, when boost pressure has been completed. The molten resin material injected from the injecting machine flowed into the runner 61, and then flowed into the film gate 5. By providing the opening valve, the injection port 60, the runner 61, and an area of the film gate 5 adjacent to the runner 61 beyond the opening valve can be formed into hot runners. In this manner, it is possible to enhance a yield by an amount of the molten resin material which has flowed into the injection port 60, the runner 61 and the film gate 5.

The molten resin material which had flowed into the film gate 5 flowed into the cavity through the gate end part 50. Because the gate end part 50 is open to the front forming surface 10, the molten resin material was injected into the cavity from a direction intersecting the front face 31 of the insert member 3.

The molten resin material flowing into the cavity flowed first into the buffer part 12. The fluid pressure of the molten resin material which had flowed into the buffer part 12 was lowered in the buffer part 12. When the buffer part 12 was filled with the molten resin material, the fluid pressure of the molten resin material was made uniform. A portion of the molten resin material which had flowed into the buffer part 12 flowed into the back buffer part 22 which is communicated with the buffer part 12. The fluid pressure of the molten resin material which had flowed into the back buffer part 22 was lowered and made uniform. The other portion of the molten resin material which had flowed into the buffer part 12 but had not flowed into the back buffer part 22 flowed into a common part 43 of the upper cavity 40 and into the intermediate cavities 42. The molten resin material which had flowed into the back buffer part 22 flowed into a common part 44 of the lower cavity 41 and into the intermediate cavities 42. Because the fluid pressure of the molten resin material had been lowered and made uniform in the buffer part 12 and the back buffer part 22, the molten resin material flowed in the upper cavity 40, the lower cavity 41, and the intermediate cavities 42, respectively, at the substantially same speed.

In the insert molding device in this embodiment, the gate end part 50 extends in the lateral direction, that is, in the direction perpendicular to the longitudinal direction of the cavity and the insert member 3. Moreover, the gate end part 50 is so formed as to stride over all the strip bodies 30. Accordingly, the molten resin material simultaneously flowed into all the intermediate cavities 42. Therefore, the fluid pressure of the molten resin material in all the intermediate cavities 42 has been made uniform. Further, by providing the buffer part 12 and the back buffer part 22, the fluid pressure of the molten resin material flowing into the intermediate cavities 42 adjacent to the buffer part 12 and the back buffer part 22 has been lowered.

Still further, the molten resin material was injected from the same position in the longitudinal direction, and therefore, the fluid pressure of the molten resin material in all the intermediate cavities 42 has been further made uniform.

After the injecting process, the insert molding device was cooled, and the molten resin material was set to form a resin member, whereby a molded product including the insert member 3 and the resin member was obtained. In the molded product thus obtained, the insert member 3 was not deformed, and the resin material has been uniformly filled in the gaps between the strip bodies 30.

In the insert molding method in the embodiment, the molten resin material is injected into the cavity through the film gate 5. Accordingly, the fluid pressure of the molten resin material in the upper cavity 40, the lower cavity 41 and the intermediate cavities 42 will be made uniform, and the insert member 3 will not be deformed. In this manner, it is possible to produce, by insert molding, the molded product in which the long resin member has been formed on the front face 31 and the back face 32 of the insert member 3, and deformation of the insert member 3 has been restrained.

In the insert molding device in the embodiment, the gate end part 50 is formed at the end of the front forming surface 10 in the longitudinal direction. However, a longitudinal position of providing the gate end part 50 is not limited to this position. There is such advantage that by providing the gate end part 50 at the end of the front forming surface 10 in the longitudinal direction, a forward flow of the molten resin material can be prevented, and the fluid pressure of the molten resin material may be made uniform.

What is claimed is:

1. An insert molding device for forming a molded product by insert molding which includes an insert member provided with a plurality of long strip bodies which are extended in a longitudinal direction so as to be in parallel with and separated from each other and each of which has a length/thickness ratio of 10 or more, and a long resin member formed on at least one of front and back faces of the insert member, the insert molding device comprising:
a cavity for receiving the insert member and for molding the resin member; and
a film gate communicated with the cavity;
wherein a gate end part of the film gate is open to a front forming surface on the cavity to form a front face of the resin member, so that the gate end part extends in a direction intersecting the longitudinal direction of the insert member.

2. An insert molding device according to claim 1, wherein a buffer part in a concave shape is formed on the front forming surface in an area including the gate end part.

3. An insert molding device according to claim 2, wherein the insert molding device has a back forming surface at a position opposed to the front forming surface, and
the back forming surface is provided with a back buffer part in a concave shape which is communicated with the buffer part at a position opposed to the buffer part.

4. An insert molding device according to claim 1, wherein the gate end part extends in a direction perpendicular to the longitudinal direction of the insert member.

5. An insert molding device according to claim 1, wherein a thickness of the resin member is 2 mm or less.

6. An insert molding device according to claim 1, wherein the gate end part is formed at an end of the front forming surface in the longitudinal direction of the insert member.

7. A molding method for molding a molded product by insert molding which includes an insert member provided with a plurality of long strip bodies which are extended in a longitudinal direction so as to be in parallel with and separated from each other and each of which has a length/thickness ratio of 10 or more, and a long resin member formed on at least one of front and back faces of the insert member, the molding method comprising the steps of:
employing an insert molding device which a cavity for receiving the insert member and for molding the resin member; and a film gate communicated with the cavity, wherein a gate end part of the film gate is open to a front forming surface on the cavity to form a front face of the resin member, so that the gate end part extends in a direction intersecting the longitudinal direction of the insert member,
mounting the insert member in the cavity,
injecting molten resin material to the cavity through the film gate from a direction intersecting a front face of the insert member.

8. A molding method according to claim 7, wherein a buffer part in a concave shape is formed on the front forming surface in an area including the gate end part,
the molten resin material flows first into the buffer part in the cavity when the molten resin material is injected to the cavity.

9. A molding method according to claim 8, wherein the insert molding device has a back forming surface at a position opposed to the front forming surface to form a back face of the resin member, and
the back forming surface is provided with a back buffer part in a concave shape which is communicated with the buffer part at a position opposed to the buffer part; and
wherein the molten resin material flows first into the buffer part, and subsequently into the back buffer part.

10. A molding method according to claim 7, wherein the gate end part of the insert molding device extends in a direction perpendicular to the longitudinal direction of the insert member, and
the molten resin material flows into respective gaps between a plurality of the strip bodies substantially at the same time, and flows into the respective gaps between a plurality of the strip bodies substantially by the same position in the longitudinal direction.

11. A molding method according to claim 7, wherein a thickness of the resin member is 2 mm or less.

12. A molding method according to claim 7, wherein the gate end part is formed at an end of the front forming surface in the longitudinal direction of the insert member.
